(19) United States
(12) Patent Application Publication
(10) Pub. No.: US 2008/0251049 A1
(43) Pub. Date: Oct. 16, 2008

(54) DEVICES FOR SUPPLYING FUEL UNDER HIGH PRESSURE BY TRANSFER PUMP

(75) Inventors: Florent Sellas, Colombes (FR); Mohamed Bouziane, Argenteuil (FR); Dominique Veret, Frondaisons (FR)

Correspondence Address: YOUNG & THOMPSON, 209 Madison Street, Suite 500, ALEXANDRIA, VA, 22314, US

(73) Assignee: CONTINENTAL AUTOMOTIVE ASNIERES FRANCE, ASNIERES SUR SEINE (FR)

(21) Appl. No.: 12/062,651

(22) Filed: Apr. 4, 2008

(30) Foreign Application Priority Data
Apr. 13, 2007 (FR) 07 02710

(51) Int. Cl. F02D 1/00; F02M 37/04

(52) U.S. Cl. 123/446; 123/456

(57) ABSTRACT

The invention relates to a device for supplying fuel under high pressure in which the fuel is put under high pressure by a transfer pump, characterized by the fact that it comprises two identical transfer pumps (3, 4), powered by a control means, controlling the fuel feed rate of the two pumps, the latter supplying the same common rail (2).

It is known to supply the injectors of a gas engine by means of what is called a common rail that receives fuel under high pressure (on the order of 120 to 200 bar) coming from a transfer pump, i.e., a pump that comprises a deformable element, whose deformations, caused by a high-pressure hydraulic fluid, have a pumping effect, at the same pressure, of fuel.

It is known to regulate the amount of fuel sent to the injector rail by said transfer pump, by means of a solenoid valve that controls, upstream from the latter, the amount of fuel allowed into the pump in that case.

It is also known by the French Patent Application 06-07181 of Aug. 4, 2006, also in the name of the applicant, to use a mono-piston pump as a transfer pump.

Such mono-piston pumps, whose flow rate of the output is controlled by regulation of the supply of the pump with fuel, have been manufactured and have been completely satisfactory.

However, the use of such mono-piston pumps for large engines, i.e., that have a number of cylinders that is higher than four and/or a large total capacity, in practice poses quite difficult problems.

In a first step, it was thought that it was enough to increase the capacity of the pump in order to increase its flow rate, but it turned out that this resulted in excessively bulky equipment.

It was therefore proposed to use several pumps.

For example, on a V (V6 or V8) engine, it is possible to use two mono-piston pumps, one on each row of cylinders.

It then turned out, however, that two control solenoid valves were necessary, which is expensive, but primarily it was necessary that they operate strictly identically since otherwise there would be variations in the power supply of the common rail.

The device for supplying fuel under high pressure according to the invention in which the regulation of the flow rate of the high-pressure pump is carried out by means of a solenoid valve that controls the amount of fuel allowed into the pump is characterized by the fact that it comprises two identical high-pressure pumps whose power supply is controlled by a single control solenoid valve.

According to a first embodiment, the means for controlling the power supply are placed in a unit that is outside of the two pumps.

According to a second embodiment, the power supply of the second pump is controlled by the control means of the first pump.

By way of example, and to facilitate the understanding of the invention, the accompanying drawings show the following:

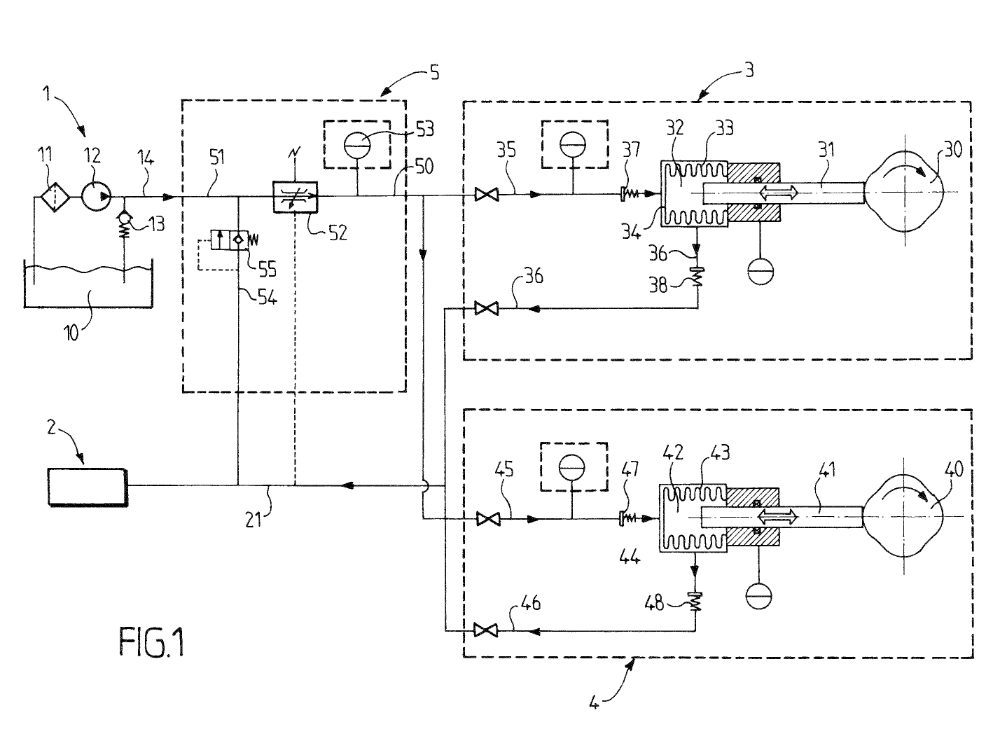

FIG. 1 is a diagrammatic view of a first embodiment of the invention;

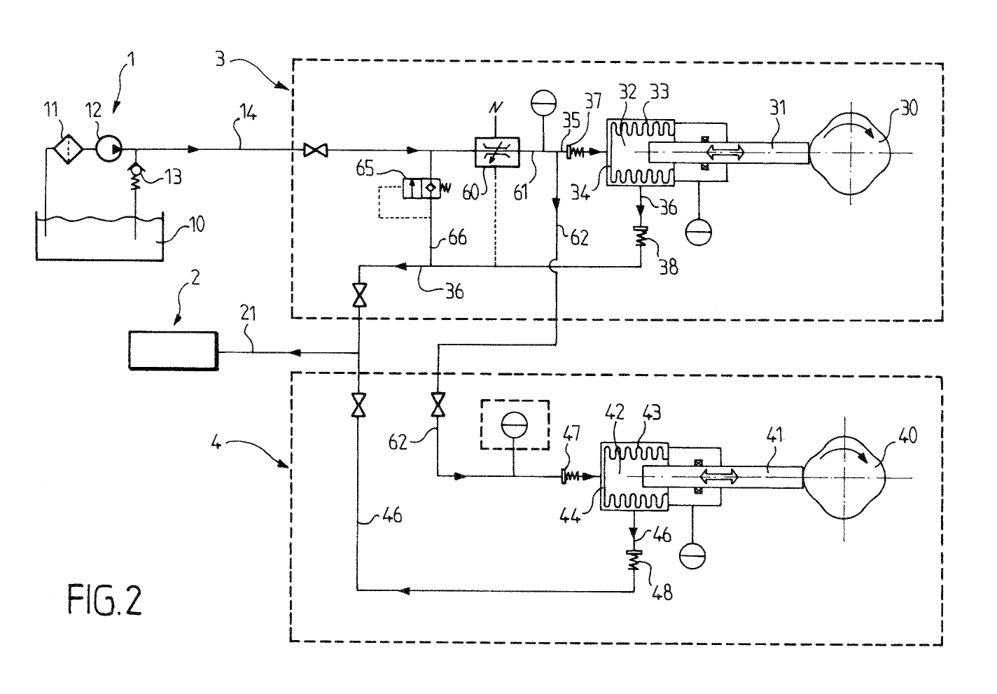

FIG. 2 is a diagrammatic view of a second embodiment of the invention;

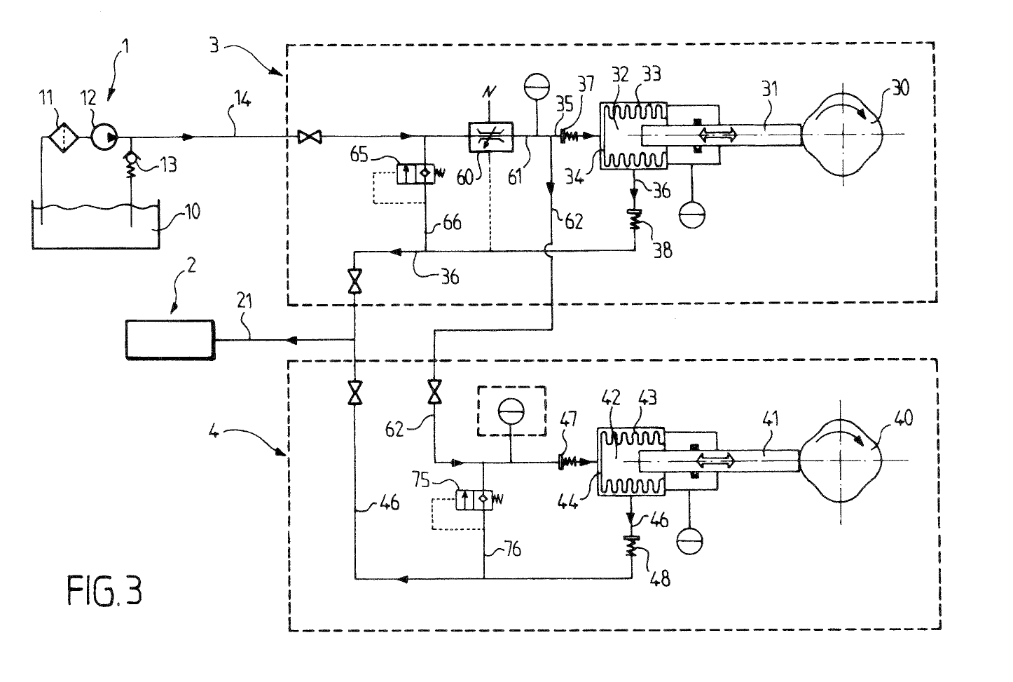

FIG. 3 is a diagrammatic view of a variant of FIG. 2.

In FIG. 1, it is seen that the fuel supply device of an engine comprises a low-pressure stage 1, a common rail 2, and two identical mono-piston pumps 3 and 4 that are designed to supply said rail 2 with fuel under high pressure, whereby the two pumps 3 and 4 are controlled upstream by a control unit 5.

The low-pressure stage comprises the fuel tank 10, a filter 11, a low-pressure pump 12 (about 5 bar), and an overpressure valve 13.

Each pump 3 and 4 is a pump of the transfer pump type with a piston 31, 41 that is driven by a cam 30, 40. The piston 31, 41 applies high pressure (120 to 200 bar) to the hydraulic fluid that is in the interior 32, 42 of a deformable bellows 33, 43, such that the fuel that comes via the feed line 35, 45 (equipped with a nonreturn valve 37, 47) into the chamber 34, 44 in which the bellows 33, 43 is placed is brought to the same pressure as that of the hydraulic fluid that is found at 32, 42.

This high-pressure fuel is evacuated through the discharge line 36, 46, equipped with a nonreturn valve 38, 48.

The discharge lines 36, 46 feed into a line 21 that supplies the rail 2.

The two feed lines 35, 45 are connected to the discharge line 50 of the control unit 5.

This control unit comprises: an intake line 51 through which the fuel comes, under low pressure, from the low-pressure stage 1; a solenoid valve 52 that regulates the amount of fuel allowed into the transfer pumps 3 and 4 through the lines 35, 45; a battery 53 and an intake line 54 at the rail 2, whereby this line 54 is equipped with a differential valve 55 that also acts as an overpressure valve.

The flow rate of the two transfer pumps 3 and 4 is regulated by the control unit 5.

The differential valve 55 receives low pressure from one side via the line 51 and high pressure via the line 54, which is linked to the line 21.

When this high pressure is cancelled following a failure of any of the components 3, 4 or 5, this valve opens and the rail 2 is powered by the low-pressure stage 1 by short-circuiting the solenoid valve 52; the engine can then operate with a low-pressure injection.

FIGS. 2 and 3 show a second embodiment in which the same elements bear the same references.

The difference arises from the fact that there is no longer a control unit that is outside of the two pumps 3 and 4, like the control unit 5 of FIG. 1.

The regulation solenoid valve 60, which is integrated in the pump 3, is used to control both said pump 3 and the pump 4.

The line 14, coming from the low-pressure stage 1, reaches the solenoid valve 60. The output 61 of this solenoid valve supplies, on the one hand, the chamber 34 of the pump 3, and, on the other hand, via a bypass 62, the chamber 44 of the second pump 4.

The differential pressure valve 65 plays the same role as the differential pressure valve 55 of FIG. 1. In the event an element fails, causing the high pressure to drop, it links the discharge line 14 of the low-pressure stage with the rail 2 via the lines 66 and 36.

The device shown in FIG. 3 is identical to the one in FIG. 2 except for the difference that there is a second differential valve 75, which has the same function as the differential valve 65.

1. Device for supplying fuel under high pressure in which the fuel is put under high pressure by a transfer pump, characterized by the fact that it comprises two identical transfer pumps (3, 4), powered by a control means, controlling the fuel feed rate of the two pumps, the latter supplying the same common rail (2).

2. Device according to claim 1, wherein the means controlling the power supply of the two pumps (3 and 4) is a unit (5), outside said pumps, comprising a control solenoid valve (52).

3. Device according to claim 2, wherein a differential pressure valve (55) directly connects the low-pressure feed stage (1) to the rail (2) in the event the high-pressure feed system fails by short-circuiting the control solenoid valve (52).

4. Device according to claim 1, wherein the control solenoid valve (60) is incorporated in the first pump (3) and supplies the second pump (4) via a bypass (62).

5. Device according to claim 4, wherein a differential pressure valve (65) that is arranged between the low-pressure line (14) and the high-pressure discharge line (36) of the first pump (3) directly connects the low-pressure feed stage (1) to the rail (2) in the event the high-pressure feed system fails by short-circuiting the control solenoid valve (60).

6. Device according to claim 5, wherein a second differential pressure valve (75) is arranged between the intake line (62) of the second pump and its discharge line so as to perform a function that is identical to that of the valve (65).
